(19) United States
(12) Patent Application Publication
(10) Pub. No.: US 2022/0314042 A1
(43) Pub. Date: Oct. 6, 2022

(54) Personal Air Filter Utilizing Mechanical, Chemical and Electrostatic Filter Media

(71) Applicant: Philter Labs Incorporated, Encinitas, CA (US)

(72) Inventors: John Grimm, Santee, CA (US); Andrew Lammoureux, Santee, CA (US)

(73) Assignee: Philter Labs Incorporated, Encinitas, CA (US)

(21) Appl. No.: 17/712,393

(22) Filed: Apr. 4, 2022

Related U.S. Application Data
(60) Provisional application No. 63/170,543, filed on Apr. 4, 2021.

(51) Int. Cl. A62B 23/02; B01D 39/12; B01D 46/00; B01D 57/02; B01D 53/00; B01D 53/86; B01D 39/20

(52) U.S. Cl. CPC A62B 23/02; B01D 39/12; B01D 46/0032; B01D 57/02; B01D 53/007; B01D 53/8671; B01D 39/2055; B01D 2255/802; B01D 2257/80; B01D 2257/504; B01D 2259/804

(57) ABSTRACT

As an accessory to smoke or vaporizer devices or integrated into same, or to accompany smokers in general, a personal air filter comprising multiple filter mediums and technologies, and various combinations thereof, including mechanical, chemical and electrostatic principles, is disclosed. The different mediums and components are sequentially incorporated into a compact unit that can fit easily into a user's bag, purse or pocket. Importantly, harmful organic compounds are targeted as well as nanoparticles. An additional feature is that the filter device is easily disassembled to replace and/or reuse inner and outer components.

### PRIORITY CLAIM

This patent application claims benefit of the priority date of U.S. Prov. Pat. App. Ser. No. 63/170,543 filed on Apr. 4, 2021 entitled “Personal Air Filter Utilizing Mechanical, Chemical and Electrostatic Filter Media.” Accordingly, the entire contents this U.S. provisional patent submission is hereby expressly incorporated by reference.

### BACKGROUND OF THE INVENTION

### Field of the Invention

The present invention pertains generally to accessories for electronic smoking devices and perhaps smoking in general. More specifically, the present invention relates to a personal air filter capable filtering exhaled pollutants including particulates and organic compounds combining various filter technologies.

### Description of the Prior Art

Ever increasing in popularity, “electronic cigarettes/e-cigarettes” and vaporizers typically use an electrical heating element to heat a liquid usually containing a mixture of nicotine and flavorings/extract (or cannabis including THC or CBD) that produces a mist similar to smoke but without the excessive heat that causes combustion.

One issue facing the so-called ENDS (Electronic Nicotine Delivery Systems) and the ECDS (Electronic Cannabis Delivery Systems) is the presence of harmful gaseous and particulate organic compounds such as formaldehyde, aldehydes, nicotine, methanol, and nitrogen oxides. Hence, it is an object of the present invention to provide devices and methods for removal such harmful particulate (or gas) in the ambient or in confined spaces. A contemplated additional benefit is the simultaneous removal of any pathogens that may be present.

As an additional object, the present invention seeks to combine various filtering technologies and filter media into a single device. For example, the invention utilizes fluid mechanics, filter mediums comprising different materials, chemical and organic breakdown of pollutants, in addition to electrostatic filter technology. Still further, a desire for earth-minded and sustainable products for filtering pollutants has emerged. Hence, therefore, it is an additional object of the present invention to provide a device comprising biodegradable, compostable, recyclable and/or reusable material wherever possible.

### BRIEF SUMMARY OF THE INVENTION

The present invention specifically addresses and alleviates the above mentioned deficiencies, more specifically, the present invention, in a first aspect is a personal air filter for filtering exhaled gaseous and particulate pollutants comprising: a top cover including a mouthpiece having an opening to engage a user's mouth, the mouthpiece having an inlet nozzle incorporated thereto; a photo catalytic oxidation material downstream of the inlet nozzle; a plurality of (downward directional and/or radially inward directional) UV (ultraviolet) light emitting diodes (LEDs), therebetween, causing particle excitation, or excitation of a particle, wherein one or more of electrons, ions, hydroxyl ions, or electron holes in a lattice structure of the photo catalytic oxidation material are exchanged between the material and the particle causing the particle to chemically oxidize thereby causing degradation to either water or carbon dioxide. A battery is further included electrically connected to and powering the plurality of LEDs. And, an outer enclosure is provided for containing and housing the plurality of LEDs, and also for housing the battery and the photo catalytic oxidation material.

The personal air filter in this first aspect is additionally characterized in that it further comprises: a passive ion element copper mesh filter medium upstream of the plurality of LEDs; a multi-faceted carriage for holding the plurality of LEDs; and an electrostatic filter media comprising two or more polymers each having opposing dielectric properties causing an exchange of ions and a static charge thereby wherein dielectrophoretic forces are created for capturing and therefore filtering very small particles (e.g. 0.05-5 μm in diameter).

The personal air filter in this first aspect is additionally characterized in that it further comprises an activated extruded carbon filter media downstream of the electrostatic filter media, the carbon filter media additionally comprising a plurality of lengthwise channels coaxially aligned to the personal air filter air path. Yet further, the invention in a preferred embodiment includes an inner enclosure bounded, or confined, by the outer enclosure for containing and housing the plurality of LEDs, and also for housing the battery and the photo catalytic oxidation material. Also included is a bottom cover including an exit vent, wherein the bottom cover and top cover together flanking the inner and outer enclosure. Importantly, in all embodiments, the top cover and the bottom cover additionally comprise short rectilinear sections flanking the outer enclosure providing structural rigidity and integrity to the outer enclosure and to the personal air filter.

The invention in other aspects may be characterized as a personal air filter having various combinations of the filtering concepts presented herein.

While the apparatus and method has or will be described for the sake of grammatical fluidity with functional explanations, it is to be expressly understood that the claims, unless expressly formulated under 35 USC § 112, or similar applicable law, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC § 112 are to be accorded full statutory equivalents under 35 USC § 112, or similar applicable law. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an isometric view of an exemplary outer an enclosures for a filter of the present invention;

FIG. 2 is an enlarged elevational view of a filter main body outer enclosure;

FIG. 3 is a cross-sectional view revealing internal components taken along line 3-3 in FIG. 2; and

FIG. 4 is an exploded view of internal components in a preferred embodiment.

### DETAILED DESCRIPTION OF PREFERRED EMBODIMENTS

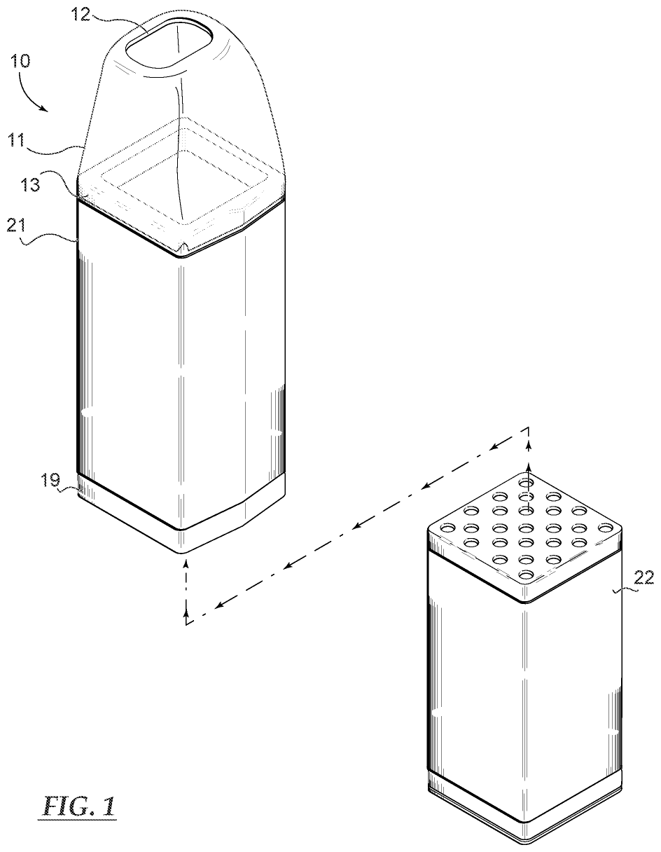

Referring initially to FIG. 1, an exemplary outer enclosure 21 is illustrated capable of housing multiple components taking advantage of multiple filtering processes. As further detailed herein, suspended particles are either filtered, attracted to materials, or chemically broken down to include very small particles, e.g. 0.05 μm in diameter being equivalent to 50 nanometers.

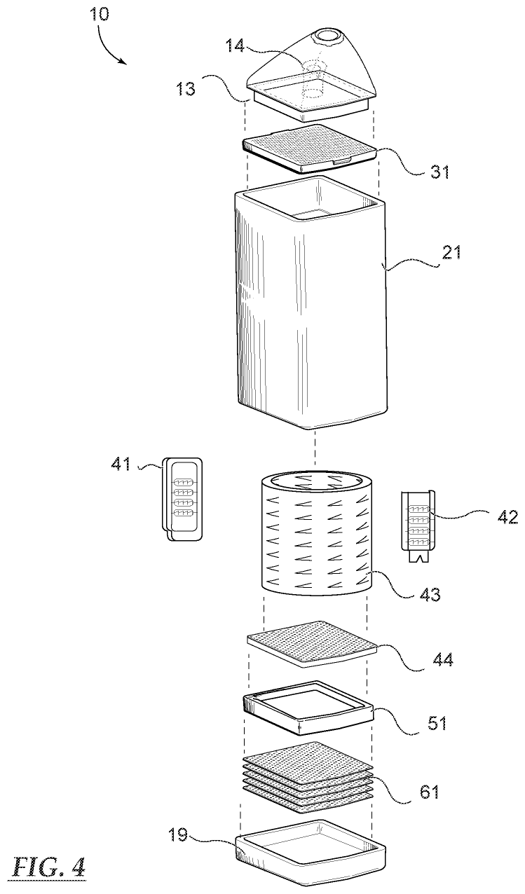

Further with reference to FIG. 1, generally the personal air filter device 10 comprises three outer components with an inner enclosure housed therein, wherein the outer components are reusable and the inner enclosure is replaceable. The three outer components comprise the outer main body enclosure 21 flanked by a top cover and a bottom cover. Further, the top cover includes a mouthpiece and both the top cover 11 and the bottom cover 19 comprise short rectilinear segments that provide structural integrity to the hollow outer enclosure. Among the important aspects of the present invention 10 is that the top cover 11 and the bottom cover 19 further comprising short rectilinear segments 13, 19 flanking the outer enclosure 21 providing structural rigidity and integrity to the outer enclosure and to the personal air filter 10. Regarding FIG. 4, these segments 13, 19 are illustrated overlapping and reinforce edges of the main body outer enclosure 21.

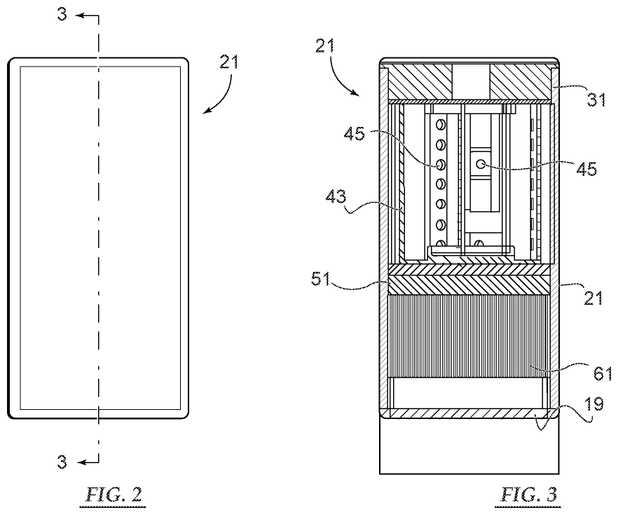

With regard to FIG. 2 and also particularly FIG. 3, all components, or combinations thereof, can fit into a compact arrangement within the outer enclosure 21, as shown. Also with regard to FIG. 4, multiple components include: a top cover 11 to an outer enclosure 21, the top cover integrating a Venturi/Bernoulli inlet nozzle 14, increasing fluid velocity and reducing pressure, and passive ion-element copper mesh 31, and a downward and/or radially inward directional (ultraviolet) UV LED module 41 with a multi-position carriage 43, as detailed herein.

Also as illustrated and with reference to FIG. 1. and FIG. 4, the invention in an initial aspect is a personal air filter for filtering exhaled gaseous and particulate pollutants comprising: a top cover 11 including an inlet nozzle 14 incorporated thereto; a photo catalytic oxidation material 44 (e.g. titanium oxide, TiO₂) downstream of the inlet nozzle 14; a plurality of downward directional UV (ultraviolet) light emitting diodes (LEDs) 41, 43, 45 therebetween, causing particle excitation (or excitation of a particle) wherein one or more of electrons, ions, hydroxyl (OH) ions, or electron holes in a lattice structure of the photo oxidation material 44 are exchanged between the material and the particle causing the particle to chemically oxidize thereby causing degradation to either water (H₂O) or carbon dioxide (CO2).

More particularly regarding titanium oxide (TiO₂) and the photocatalytic oxidation material 44, the photocatalytic oxidation material is based in TiO₂ and promotes and accelerates the degradation of organic molecules, such as aldehydes, nicotine, methanol, and nitrogen oxides, and contribute to improving the air quality in outdoor gathering areas and indoors. Therein, a chemical reaction between highly reactive radicals, such as hydroxyl radicals and superoxide ions, takes place and oxidizes the pollutants to harmless CO2 and water. The superoxide ions are highly reactive charged particles and include harmful pollutants, such as formaldehyde.

In this preferred embodiment and with regard to FIG. 4, the invention includes a battery 42 electrically connected to and powering the plurality of LEDs and an outer enclosure 21 for containing and housing the plurality of LEDs, the battery 42 and the photo catalytic oxidation material 44. Some embodiments may incorporate an inner enclosure 22 (e.g. FIG. 1) that house components with the outer enclosure 21 confining same 22.

Particularly with regard to FIG. 3, the personal air filter is additionally characterized as having a passive ion element copper mesh 31 filter medium upstream of the plurality of LEDs 45. FIG. 4 illustrates a multi-faceted carriage 43 for holding the plurality of LEDs; and an electrostatic filter media 51 comprising two or more polymers each having opposing dielectric properties causing an exchange of ions and a static charge thereby wherein dielectrophoretic forces (and/or both coulombic forces) are created for capturing and further filtering very small particles (e.g. 0.05 μm-5 μm). The personal combination air filter 10 herein also includes an activated extruded carbon filter medium 61 downstream of the electrostatic filter media 51. As illustrated in FIG. 3, the carbon filter medium 61 additionally comprises a plurality of lengthwise channels coaxially aligned to the personal air filter air path. Lastly in a preferred embodiment (FIG. 3), a bottom vent cover 19 is positioned at an outlet to the carbon filter 61 also providing structural integrity to the personal air filter 10.

Alternatively with regard to FIG. 1, FIG. 2 and FIG. 3, the invention 10 comprises: a top cover 11 including a mouthpiece having an opening 12 to engage a user's mouth; a main body outer enclosure 21 configured to the top cover 11; and an inner enclosure 22 removable and bound by the outer enclosure 21. The inner enclosure further includes a (passive ion element) copper mesh filter medium 31 for filtering harmful pollutants. This copper mesh filter medium 31 (and perhaps other components) will invariably have a finite useful life. Hence the inner enclosure 22 is designed removable and replaceable after an expiration of such finite useful life.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

While the particular Personal Air Filter Utilizing Mechanical Chemical and Electrostatic Filter Media as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A personal air filter for filtering exhaled gaseous and particulate pollutants comprising:
a mouthpiece having an opening to engage a user's mouth;
a copper mesh filter downstream of the mouthpiece; and
an electrostatic filter media comprising two or more polymers each having opposing dielectric properties causing an exchange of ions and a static charge thereby wherein dielectrophoretic forces are created for capturing and therefore filtering very small particles approximately in a range of 0.05 μm to 5 μm in diameter.

2. The personal air filter of claim 1 further comprising:
a plurality of LEDs;
a photo catalytic oxidation material;
a multi-faceted carriage for holding the plurality of LEDs, the multi-faceted carriage being multi-directional comprising a downward direction and a radial inward direction, the plurality of LEDs causing excitation of a particle wherein one or more of electrons, ions, hydroxyl ions, or electron holes in a lattice structure of the photo catalytic oxidation material are exchanged between the photo catalytic oxidation material and the particle causing the particle to chemically oxidize thereby causing degradation to either water or carbon dioxide; and
a battery electrically connected to and powering the plurality of LEDs and
an outer enclosure for containing and housing the plurality of LEDs, the battery and the photo catalytic oxidation material.

3. The personal air filter of claim 2 further comprising an inner enclosure removable and bound by the outer enclosure, the inner enclosure comprising the copper mesh filter medium for filtering said pollutants, the copper mesh filter medium having a finite useful life, wherein the inner enclosure is replaceable after an expiration of the finite useful life.

4. A personal air filter for filtering exhaled gaseous and particulate pollutants comprising:
a top cover including a mouthpiece having an opening to engage a user's mouth;
a main body outer enclosure configured to the top cover; and
an inner enclosure removable and bound by the outer enclosure, the inner enclosure comprising a copper mesh filter medium for filtering said pollutants, the copper mesh filter medium having a finite useful life, wherein the inner enclosure is replaceable after an expiration of the finite useful life.

5. The personal air filter of claim 4, the inner enclosure further comprising an electrostatic filter media comprising two or more polymers each having opposing dielectric properties causing an exchange of ions and a static charge thereby wherein dielectrophoretic forces are created for capturing and therefore filtering very small particles approximately in a range of 0.05 μm to 5 μm in diameter.

6. A personal air filter for filtering exhaled gaseous and particulate pollutants comprising:
a top cover including a mouthpiece having an opening to engage a user's mouth;
a photo catalytic oxidation material downstream of the mouthpiece;
a plurality of UV (ultraviolet) light emitting diodes (LEDs), therebetween, causing excitation of a particle wherein one or more of electrons, ions, hydroxyl ions, or electron holes in a lattice structure of the photo catalytic oxidation material are exchanged between the material and the particle causing the particle to chemically oxidize thereby causing degradation to either water or carbon dioxide;
a battery electrically connected to and powering the plurality of LEDs; and
an outer enclosure for containing and housing the plurality of LEDs, the battery and the photo catalytic oxidation material.

7. The personal air filter of claim 6 further comprising:
a copper mesh filter medium upstream of the plurality of LEDs;
a multi-faceted carriage for holding the plurality of LEDs; and
an electrostatic filter media comprising two or more polymers each having opposing dielectric properties causing an exchange of ions and a static charge thereby wherein dielectrophoretic forces are created for capturing and therefore filtering very small particles.

8. The personal air filter of claim 6 further comprising an activated extruded carbon filter media downstream of the electrostatic filter media, the carbon filter media additionally comprising a plurality of lengthwise channels coaxially aligned to the personal air filter air path.

9. The personal air filter of claim 6 wherein the top cover comprises an inlet nozzle downwardly aligned to increase fluid velocity and decrease pressure of a user's exhale.

10. The personal air filter of claim 6 further comprising:
an inner enclosure bounded by said outer enclosure for containing and housing the plurality of LEDs, the battery and the photo catalytic oxidation material; and
a bottom cover including an exit vent, the bottom cover and top cover together flanking the inner and outer enclosure.

11. The personal air filter of claim 10, the top cover and the bottom each further comprising short rectilinear segments flanking the outer enclosure providing structural integrity to the outer enclosure and to the personal air filter.
